(19) United States
(12) Patent Application Publication
(10) Pub. No.: US 2024/0174516 A1
(43) Pub. Date: May 30, 2024

(54) REVERSE FLOW REACTOR FOR AMMONIA CRACKING

(71) Applicant: EXXONMOBIL TECHNOLOGY AND ENGINEERING COMPANY, Annandale, NJ (US)

(72) Inventors: Everett J. O'NEAL, Spring, TX (US); David C. DANKWORTH, Princeton, NJ (US); Sarah E. FEICHT, Branchburg, NJ (US)

(21) Appl. No.: 18/520,882

(22) Filed: Nov. 28, 2023

Related U.S. Application Data
(60) Provisional application No. 63/385,450, filed on Nov. 30, 2022.

(51) Int. Cl. C01B 3/04

(52) U.S. Cl. CPC C01B 3/047; C01B 2203/1058; C01B 2203/1076; C01B 2203/1205

(57) ABSTRACT

Systems and methods are provided for performing ammonia cracking as the endothermic reaction step of a reaction cycle in a cyclic reaction environment, such as a reverse flow reaction environment. In such aspects, heat for the endothermic reaction can be provided by direct heating during a regeneration step. Optionally, the fuel for the regeneration step can correspond to additional ammonia and/or can include hydrogen generated during the ammonia cracking reaction step. Optionally, a selective catalytic reduction (SCR) zone can be included as part of the reactor, to reduce or minimize the amount of nitrogen oxides in the regeneration effluent from the reactor.

### CROSS-REFERENCE TO RELATED APPLICATIONS AND PRIORITY CLAIM

This Non-Provisional patent application claims priority to U.S. Provisional Patent Application No. 63/385,450, filed Nov. 30, 2022, and titled “Reverse Flow Reactor For Ammonia Cracking”, the entire contents of which is incorporated herein by reference.

### FIELD OF THE INVENTION

Methods are provided for operating reactors such as reverse flow reactors to perform ammonia cracking.

### BACKGROUND OF THE INVENTION

Reverse flow reactors are an example of a reactor type that is beneficial for use in processes with cyclic reaction conditions. For example, due to the endothermic nature of reforming reactions, additional heat needs to be introduced on a consistent basis into the reforming reaction environment. Reverse flow reactors can provide an efficient way to introduce heat into the reaction environment. After a portion of the reaction cycle used for reforming or another endothermic reaction, a second portion of the reaction cycle can be used for combustion or another exothermic reaction to add heat to the reaction environment in preparation for the next reforming step. U.S. Pat. Nos. 7,815,873 and 8,754,276 provide examples of using reverse flow reactors to perform various endothermic processes in a cyclic reaction environment.

One application for reverse flow reactors is reforming of hydrocarbons to make H₂. By operating at high temperatures, the amount of unreacted hydrocarbons in the H₂ can be reduced or minimized. This can make the resulting H₂ from a reverse flow reactor a suitable input feed for synthesis of ammonia, such as via the Haber process. International Publication WO/2022/060355 describes integration of hydrocarbon reforming in a reverse flow reactor with synthesis of ammonia and/or urea.

Another example of an endothermic reaction that can produce H₂ is ammonia cracking. During ammonia cracking, ammonia is converted into H₂ and N₂. U.S. Pat. No. 10,450,192 describes an example of an ammonia cracking process.

U.S. Patent Application Publication 2014/0105802 describes a treatment for reducing or minimizing NOx content in the reaction flow and/or effluent of a regenerative pyrolysis reactor.

### SUMMARY OF THE INVENTION

In an aspect, a method for cracking ammonia in a cyclic flow reaction system is provided. The method includes mixing a fuel flow containing ammonia and a first O₂-containing flow in a reaction system to form a mixture having an O₂ content of 0.1 vol % or more. The reaction system can include a reaction zone and a recuperation zone. The method further includes reacting the mixture to heat one or more surfaces in the reaction zone to a cracking temperature. At least a portion of the reaction zone can include a cracking catalyst. Additionally, the method includes exposing a reactant stream containing ammonia to the cracking catalyst in the reaction zone under cracking conditions to form a hydrogen-containing effluent. A direction of flow of the reactant stream can be reversed relative to a direction of flow for the mixture.

In another aspect, a reverse flow reactor system is provided. The system includes a reaction zone containing a cracking catalyst. The system further includes a recuperation zone having a fuel inlet, an oxidant inlet, and a reaction effluent outlet. The system further includes mixer at an interface between the recuperation zone and the reaction zone, the recuperation zone having at least one recuperation zone flow path providing fluid communication between the fuel inlet and the mixer. Additionally, the system includes a selective catalytic reduction zone having a catalytic reduction catalyst, an ammonia reactant inlet, and a flue gas outlet.

### BRIEF DESCRIPTION OF THE DRAWINGS

FIG. 1 shows an example of a reaction system for performing ammonia cracking.

FIG. 2 shows another example of a reaction system for performing ammonia cracking.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, systems and methods are provided for performing ammonia cracking as the endothermic reaction step of a reaction cycle in a cyclic reaction environment, such as a reverse flow reaction environment. In such aspects, heat for the endothermic reaction can be provided by direct heating during a regeneration step. Optionally, the fuel for the regeneration step can correspond to additional ammonia and/or can include hydrogen generated during the ammonia cracking reaction step. Optionally, a selective catalytic reduction (SCR) zone can be included as part of the reactor, to reduce or minimize the amount of nitrogen oxides in the regeneration effluent from the reactor.

Ammonia can be stored and/or transported as a condensed phase fluid under substantially less severe conditions than molecular hydrogen. Thus, ammonia has the potential to be used as a transportable fuel that can then be converted into hydrogen after transport to a location. A reactor system such as a reverse flow reactor can allow the ammonia to be converted to hydrogen using only the ammonia and/or hydrogen generated from the ammonia as the heating source for the reactor. This can provide advantages for situations where hydrogen is desirable as a fuel, but infrastructure for storing and delivering hydrogen may be limited.

One of the advantages of a reverse flow reaction environment/reactor system is that the heat for the reaction step is provided by direct heating of surfaces within the reaction environment during a regeneration step. Using direct heating (where oxidation of fuel to provide heat is performed within the reaction environment for the subsequent reaction step) can reduce or minimize losses associated with heat transfer. This is in contrast to indirect heating, where combustion of fuel is performed in a separate volume and then heat is transferred into the reaction volume, such as by transfer of heat through the walls surrounding the reaction zone or volume.

Conventionally, heat for performing an endothermic reaction is typically provided by combustion of a hydrocarbon, such as natural gas. However, due in part to the nature of the reaction environment in a reverse flow reactor, oxidation and/or combustion of ammonia can be used to provide at least a portion of the heat. This can allow for conversion of ammonia into hydrogen while avoiding formation of carbon oxides.

It is noted that combustion of ammonia can result in formation of nitrogen oxides during the regeneration step. In some aspects, the regeneration effluent can be treated after exiting from the reaction system to reduce, minimize, or eliminate the nitrogen oxides. An example of a suitable process for reducing or minimizing nitrogen oxides is selective catalytic reduction. Additionally or alternately, a selective catalytic reduction zone can be incorporated into the reaction system in order to reduce or minimize nitrogen oxides in the effluent prior to exiting from the reaction system.

In various aspects, systems and methods are provided that overcome one or more of the above challenges to allow for performing both steam reforming and partial oxidation during the reaction step within a cyclic reaction environment that is heated by direct heating, such as a reverse flow reactor system environment. In some aspects, the mixer or mixing zone in the reactor system can be configured to allow for selective mixing of input flows during both the reaction step and the regeneration step. During the regeneration step, the mixer can provide the traditional function of delaying the mixing of oxidant with fuel, so that oxidation (such as combustion) of the fuel does not occur until the fuel is within or near to the reaction zone/reforming zone. During the reaction step, where the flows are in the opposite direction, the mixer can delay the mixing of oxidant with the reforming input flow and/or the reforming effluent, so that partial oxidation is reduced, minimized, or avoided until after the reforming effluent enters the recuperation zone.

### Reactor Configuration

In this discussion, a reactor system for performing ammonia cracking can have either two or three zones/reactors. One zone/reactor corresponds to the ammonia cracking zone in the reactor system. This can be referred to as the cracking zone, the cracking reactor, or the reaction zone. Another zone/reactor corresponds to the recuperation zone. This can be referred to as the recuperation zone or recuperation reactor. When a third zone is present, the third zone can correspond to a selective catalytic reduction zone. A mixer can typically be included between the recuperation zone and the reaction zone, to allow ammonia and oxidant to mix at a target location for combustion near the interface between the recuperation zone and reaction zone. When a third zone for selective catalytic reduction is present, a second mixer can be included between the reaction zone and selective catalytic reduction zone to allow for mixing of ammonia (or another reductant) with the regeneration unit to facilitate the selective catalytic reduction process. The zones can have at least one common flow path, with the zones optionally having a common axis. The common axis can be horizontal, vertical, or any other convenient orientation. Based on the common flow path, the reaction zone can provide fluid communication between the recuperation zone and the optional selective catalytic reduction zone.

In a reverse flow reactor system, the heat needed for an endothermic reaction may be provided by creating a high-temperature heat bubble in a middle portion of the reactor system. A two-step process can then be used wherein heat is (a) added to the reactor bed(s) or monolith(s) via in-situ combustion (or more generally, oxidation of the fuel), and then (b) removed from the bed in-situ via an endothermic process, such as ammonia cracking. This type of configuration can provide the ability to consistently manage and confine the high temperature bubble in a reactor region(s) that can tolerate such conditions long term. A reverse flow reactor system can allow the primary endothermic and regeneration processes to be performed in a substantially continuous manner.

During the reaction step, the input flow can correspond to ammonia. Optionally, the input flow for the reaction step can substantially correspond to ammonia, with the amount of components other than ammonia (or other than ammonia and N₂) being reduced or minimized. By reducing or minimizing the number of other components in the input flow for the reaction step, contamination of the resulting H₂ with components other than nitrogen can be reduced or minimized. The ammonia can be exposed to a catalyst that provides activity for cracking ammonia, such as a nickel-based catalyst.

In some aspects, the fuel flow during the regeneration step can correspond to ammonia. In other aspects, at least a portion of the hydrogen-containing effluent generated during the ammonia cracking can be used as part of the fuel flow. Although the hydrogen-containing effluent could be used alone, in some aspects a more efficient use of hydrogen can be to add a minor amount of hydrogen to an ammonia fuel. This can be beneficial in some instances for controlling the speed of combustion of the fuel, which can assist with controlling the location of peak temperature within the reactor. In some aspects, the fuel flow can contain 5.0 vol % or less of H₂, or 3.0 vol % or less, or 1.0 vol % or less, such as down to 0.05 vol % or possibly still lower. In some alternative aspects, a hydrocarbon-based fuel can be used as the fuel for the regeneration step. During the regeneration step, the oxidant flow can be air, oxygen from an air separation unit, a combination thereof, and/or another convenient source of oxygen. In some aspects, the amount of oxygen in the mixture of fuel and oxygen can correspond to a stoichiometric excess, such as between 90% and 200% of the stoichiometric amount for combustion of the fuel, or 100% to 200%, or 90% to 120%, or 100% to 120%, or 90% to 110%, or 100% to 110%. Additionally or alternately, the oxidant flow can contain 22.0 vol % or less of O₂, or 10.0 vol % or less, or 5.0 vol % or less, such as down to 0.05 vol % or possibly still lower. Further additionally or alternately, after combination of fuel with oxidant, the combined flow can contain 22.0 vol % or less of 02, or 10.0 vol % or less, or 5.0 vol % or less, such as down to 0.1 vol % or possibly still lower.

During regeneration, at least one of the fuel flow and oxidant flow is introduced into the reactor system at or near the end of the reactor system corresponding to the recuperation zone. This allows the fuel and/or oxidant flow to be heated by heat stored in the recuperation zone. In order to delay the location of combustion of fuel until the fuel is at or near the location of reforming zone, the fuel flow and oxidant flow can be introduced into the reactor via separate channels. For example, the fuel flow can be introduced into the primary volume and/or primary flow channels, while a separate set of channels can be used to introduce the oxidant flow, such as air or another O₂-containing gas. By delaying the mixing of the fuel and oxidant, the location of combustion can be controlled, so that heat is delivered primarily to the portion of the reactor system is located. This allows a high temperature zone or heat bubble to form in the middle of the reactor system. The heat bubble can correspond to a temperature that is at least about the initial temperature for the endothermic reaction. Typically, the temperature of the heat bubble can be greater than the initial temperature for the endothermic reaction, as the temperature will decrease as heat is transferred from the heat bubble in a middle portion of the reactor toward the ends of the reactor. The combustion process can take place over a long enough duration that the flow of fuel/oxidant/resulting flue gas also serves to displace a substantial portion of the heat produced by the reaction (e.g., the heat bubble), into and at least partially through the reforming zone, but preferably not all of the way through the reforming zone to avoid waste of heat. The flue gas may be exhausted through the end of the reactor corresponding to the reforming zone, but preferably most of the heat is retained within the reforming zone. The amount of heat displaced into the reforming zone during the regeneration step can also be limited or determined by the desired exposure time or space velocity that the ammonia input gas flow will have during the subsequent reaction step (ammonia cracking).

After the regeneration or heating step, in the next/reverse step of the cycle, ammonia for ammonia cracking can be supplied or flowed through the reaction zone from the direction opposite the direction of flow during the heating step. The ammonia can contact a suitable cracking catalyst (such as a nickel catalyst) in the heat bubble region to transfer heat to the ammonia for reaction energy. This provides at least a portion of the heat for performing the cracking reaction.

Although delaying combustion of fuel during the regeneration step can allow a heat bubble to form in the middle of the reactor, using separate flow channels to deliver the oxidant to roughly the desired location for the combustion reaction means that the fuel and oxidant are not well-mixed prior to entering the reactor system. In order to reduce or minimize variations in the temperature profile across the cross-section of a reactor, mixing elements can be used to assist with mixing the fuel flow and oxidant flow.

Optionally, selective catalytic reduction (SCR) can also be performed within the reaction system. For example, selective catalytic reduction can be performed by exposing nitrogen oxides to a catalyst in the presence of a reductant, such as ammonia.

In some aspects, SCR catalysts can be based on oxides of base metals, such as vanadium, molybdenum, and/or tungsten. Optionally, the catalytic metal can be supported on a porous ceramic material, such as titanium oxide. In other aspects, the catalyst can correspond to a zeolitic material. The SCR can be performed at a temperature between 300° C. and 500° C.

There are several options for providing ammonia (or another reductant) to the selective catalytic reduction zone. One option is to have an ammonia input that is downstream from the combustion location, such as at the interface between the reaction zone and the selective catalytic reduction zone. Another option can be to bypass a portion of the ammonia introduced into the recuperation zone, so that the portion of the ammonia is not mixed with oxidant. After introduction of the additional ammonia, mixing of the ammonia with the regeneration effluent can be facilitated by using one or more mixing elements. In some aspects, the mixing elements can define the interface between the reaction zone and the selective catalytic reduction zone. In some aspects, the interface between the reaction zone and the selective catalytic reduction zone can be defined based on the location where the additional ammonia is added to the reaction system. In still other aspects, the interface between the reaction zone and the SCR zone can be defined based on the end of the region where ammonia cracking catalyst is located.

It is further noted that some SCR can be performed even if a separate reductant is not added to the system at or near the beginning of the optional SCR zone. During the reaction step, the SCR zone can become saturated with ammonia as the ammonia passes through the SCR zone to enter the reaction zone. When the next regeneration step starts, if a purge is not performed, the SCR zone will initially contain ammonia. If there is pore volume present in the SCR zone, such as due to having a porous monolith that provides support for SCR catalyst, ammonia can be present in the pore volume. This ammonia can at least partially serve as a reductant. Thus, it may be possible to perform sufficient SCR without adding a separate reductant input. Or, some SCR can be performed in the reaction system without adding a separate reductant, while the remaining SCR is performed in an external reactor.

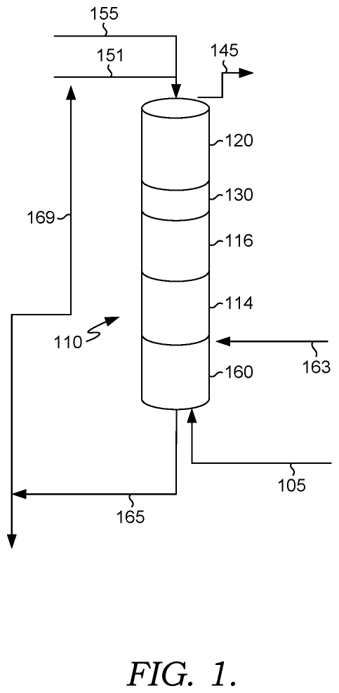

FIG. 1 shows an example of a reactor system configuration for performing ammonia cracking in a reverse flow reactor. In FIG. 1, the flows for both the ammonia cracking step and the regeneration step are shown. However, during operation, the flows for ammonia cracking would be alternated with the flows for regeneration.

In the example shown in FIG. 1, during ammonia cracking, a feed flow 105 containing ammonia is passed into the reaction system. In FIG. 1, the reaction zone 110 is shown as containing two monoliths 114 and 116 that are wash coated with a catalyst system that includes a nickel catalyst. Although two monoliths 114 and 116 are shown, any convenient number of monoliths can be used. The feed flow 105 is exposed to the nickel catalyst supported on monoliths 114 and 116 to convert NH₃ into H₂ and N₂. The conversion effluent 145 then passes through mixer 130 and recuperation zone 120 prior to being exhausted from the reactor. This allows for additional transfer of heat from conversion effluent 145 to recuperation zone 120. The recuperation zone 120 can then be used to pre-heat the flows for the subsequent regeneration step.

After the reaction step (for ammonia cracking) is finished, the regeneration step can begin. It is noted that a purge step between ammonia cracking and regeneration is not required, but could be performed if desired. During regeneration, a fuel flow 155 (such as an ammonia flow) is passed into the reactor through the recuperation zone. An oxidant flow 151, such as air, is also introduced into the reactor. At least one of oxidant flow 151 and fuel flow 155 is introduced into the reaction system via a separate set of channels, so that oxidant flow 151 and fuel flow 155 do not mix until the flows reach mixer 130. After mixing, the fuel and oxidant react to provide heat for the reaction system. The products from combustion flow through the reaction system carrying heat from the combustion reaction, which transfers heat to one or more surfaces in reaction zone 110. In the example configuration shown in FIG. 1, the transfer of heat to one or more surfaces in reaction zone 110 can include heating of monoliths 114 and 116.

In some aspects, the products from the combustion flow can be exhausted from the reaction system without further modification. In other aspects, such as in the configuration shown in FIG. 1, the combustion products can be exposed to selective catalytic reduction conditions in optional selective catalytic reduction (SCR) zone 160. The selective catalytic reduction conditions can include exposing the combustion products to a suitable catalyst in the presence of a reductant in order to convert nitrogen oxides to N₂ and H₂O. This forms an effluent 165 with a reduced or minimized content of nitrogen oxides. As shown in FIG. 1, a portion 169 of the effluent 165 can be recycled for use as part of fuel flow 155. In the example shown in FIG. 1, an additional ammonia stream 161 is added to the reactor at the beginning of SCR zone 160. It is noted that in other embodiments, the SCR zone can represent a separate reactor located downstream from the reaction system.

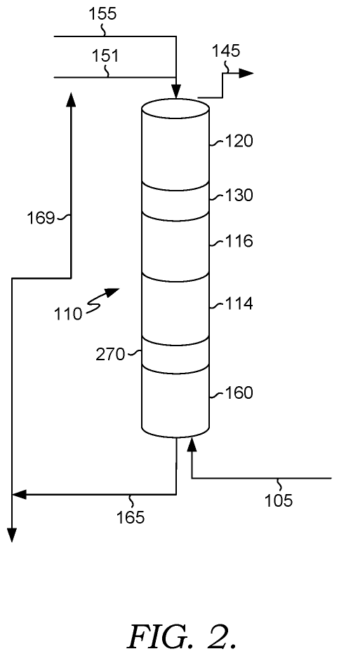

FIG. 2 shows a reaction system similar to FIG. 1 but with a different configuration for delivering reductant to the optional SCR zone 160. In the example configuration shown in FIG. 2, an additional mixer 270 is included between the reaction zone 110 and optional SCR zone 160. During the regeneration step, a portion of fuel (ammonia) 155 is diverted into separate channels (not shown) that bypass mixer 130 and reaction zone 110. This bypassed ammonia arrives at additional mixer 270 without having been exposed to an oxidant under combustion conditions. This bypassed ammonia is mixed with the combustion products in additional mixer 270 to provide reductant for the SCR process.

It is noted that the oxidant flow for the regeneration step (such as oxidant flow 151) can have any convenient content of O₂. In various aspects, the O₂ content of the oxidant stream for the regeneration step can range from 10 vol % to 100 vol %, or 10 vol % to 60 vol %, or 10 vol % to 40 vol %, or 20 vol % to 100 vol %, or 20 vol % to 80 vol %, or 20 vol % to 60 vol %, or 20 vol % to 40 vol %, or 40 vol % to 100 vol %, or 60 vol % to 100 vol %, or 80 vol % to 100 vol %. In aspects where O₂ from an air separation unit is used as part of the oxidant flow for regeneration, O₂ can be diluted with H₂O to improve the heat transport properties of the gas flow.

Both the reforming zone 110 and the recuperation zone 120 can contain regenerative monoliths and/or other regenerative structures. Regenerative monoliths or other regenerative structures, as used herein, comprise materials that are effective in storing and transferring heat as well as being effective for carrying out a chemical reaction. The regenerative monoliths and/or other structures can correspond to any convenient type of material that is suitable for storing heat, transferring heat, and catalyzing a reaction. Examples of structures can include bedding or packing material, ceramic beads or spheres, ceramic honeycomb materials, ceramic tubes, extruded monoliths, and the like, provided they are competent to maintain integrity, functionality, and withstand long term exposure to temperatures in excess of 1000° C., or in excess of 1200° C., which can allow for some operating margin.

In some aspects, the recuperator can be comprised of one or more extruded honeycomb monoliths, as described above. Each monolith may provide flow channel(s) (e.g., flow paths) for one of the first or second reactants. Each channel preferably includes a plurality of conduits. Alternatively, a monolith may comprise one or more channels for each reactant with one or more channels or groups of conduits dedicated to flowing one or more streams of a reactant, while the remaining portion of conduits flow one or more streams of the other reactant. It is recognized that at the interface between channels, a number of conduits may convey a mixture of first and second reactant, but this number of conduits is proportionately small.

Alternative embodiments may use reactor media other than monoliths, such as whereby the channel conduits/flow paths may include a more tortuous pathways (e.g. convoluted, complex, winding and/or twisted but not linear or tubular), including but not limited to labyrinthine, variegated flow paths, conduits, tubes, slots, and/or a pore structure having channels through a portion(s) of the reactor and may include barrier portion, such as along an outer surface of a segment or within sub-segments, having substantially no effective permeability to gases, and/or other means suitable for preventing cross flow between the reactant gases and maintaining the first and second reactant gases substantially separated from each other while axially transiting the recuperation zone. Such other types of reactor media can be suitable, so long as at least a portion of such media can be formed by sintering a ceramic catalytic composition as described herein, followed by exposing such media to reducing conditions to activate the catalyst. For such embodiments, the complex flow path may create a lengthened effective flow path, increased surface area, and improved heat transfer. Such design may be preferred for reactor embodiments having a relatively short axial length through the reactor. Axially longer reactor lengths may experience increased pressure drops through the reactor. However for such embodiments, the porous and/or permeable media may include, for example, at least one of a packed bed, an arrangement of tiles, a permeable solid media, a substantially honeycomb-type structure, a fibrous arrangement, and a mesh-type lattice structure.

In some aspects, the regenerative bed(s) and/or monolith(s) of the recuperation zone can comprise channels having a gas or fluid barrier that isolates the first reactant channels (e.g., containing fuel) from the second reactant channels (e.g., containing oxidant). Thereby, both of the at least two reactant gases that transit the channel means may fully transit the regenerative bed(s), to quench the regenerative bed, absorb heat into the reactant gases, before combining to react with each other in the mixing zone.

By keeping the fuel and oxidant substantially separated, the location of the heat release that occurs due to exothermic reaction can be controlled. In some aspects “substantially separated” can be defined to mean that at least 50 percent, or at least 75 percent, or at least 90 percent of the reactant having the smallest or limiting stoichiometrically reactable amount of reactant, as between the first and second reactant streams, has not become consumed by reaction by the point at which these gases have completed their axial transit of the recuperator. In this manner, the majority of the first reactant (such as fuel flow 155) can be kept isolated from the majority of the second reactant (such as oxidant flow 151), and the majority of the heat release from the reaction of combining the reactants can take place after the reactants begin exiting the recuperator and/or after the reactants enter the mixer. The reactants can be gases, but optionally some reactants may comprise a liquid, mixture, or vapor phase.

The percent reaction for these regeneration streams is defined as the percent of reaction that is possible based on the stoichiometry of the overall feed. For example, if the oxidant flow comprises 100 volumes of air (80 volumes N₂ and 20 Volumes O₂), and the fuel flow comprises 10 volumes of hydrogen, then the maximum stoichiometric reaction would be the combustion of 10 volumes of hydrogen (H₂) with 5 volumes of oxygen (O₂) to make 10 volumes of H₂O. In this case, if 10 volumes of hydrogen were actually combusted in the recuperator zone, this would represent 100% reaction of the regeneration stream. This is despite the presence of residual un-reacted oxygen, because in this example the un-reacted oxygen was present in amounts above the stoichiometric requirement. Thus, in this example the hydrogen is the stoichiometrically limiting component. Using this definition, less than 50% reaction, or less than 25% reaction, or less than 10% reaction of the regeneration streams can occur during the axial transit of the recuperation zone.

In various aspects, channels can comprise ceramic (including zirconia), alumina, or other refractory material capable of withstanding temperatures exceeding 1200° C. Additionally or alternately, channels can have a wetted area between 50 ft⁻¹ and 3000 ft⁻¹, or between 100 ft⁻¹ and 2500 ft⁻¹, or between 200 ft⁻¹ and 2000 ft⁻¹.

### Process Example—Ammonia Cracking and Regeneration

Ammonia cracking is an endothermic reaction. One of the challenges in commercial scale ammonia cracking is providing the heat for performing the cracking reaction in an efficient manner while reducing or minimizing introduction of additional components into the desired hydrogen gas product. Cyclic reaction systems, such as reverse flow reactor systems, can provide heat in a desirable manner by having a cycle including a reaction (cracking) step and a regeneration step. During the regeneration step, combustion can be performed within a selected area of the reactor. A gas flow during regeneration can assist with transferring this heat from the combustion zone toward additional portions of the reaction zone in the reactor. The reaction step within the cycle can be a separate step, so that incorporation of products from combustion into the reactants and/or products from ammonia cracking can be reduced or minimized. The cracking step can consume heat, which can reduce the temperature of the reaction zone. As the products from ammonia cracking pass through the reactor, the cracking products can pass through a recuperation zone that lacks a cracking catalyst. This can allow the reaction products to cool prior to exiting the reactor. The heat transferred from the cracking products to the reactor can then be used to increase the temperature of the reactants for the next combustion or regeneration step.

Within the reaction zone of a reverse flow reactor, the temperature can vary across the zone due to the nature of how heat is added to the reactor and/or due to the kinetics of the cracking reaction. The highest temperature portion of the zone can typically be found near a middle portion of the reactor. This middle portion can be referred to as a mixing zone where combustion is initiated during regeneration. At least a portion of the mixing zone can correspond to part of the cracking zone if a monolith with cracking catalyst extends into the mixing zone. As a result, the location where combustion is started during regeneration can typically be near to the end of the cracking zone within the reactor. Moving from the center of the reactor to the ends of the reactor, the temperature can decrease. As a result, the temperature at the beginning of the cracking zone (at or near the end of the reactor) can be cooler than the temperature at the end of the cracking zone (in a middle portion of the reactor).

As the cracking reaction occurs, the temperature within the cracking zone can be reduced. The rate of reduction in temperature can be related to the kinetic factors of the amount of available ammonia for cracking and/or the temperature at a given location within the reforming zone. As the ammonia feed moves through the cracking zone, the reactants in the feed can be consumed, which can reduce the amount of cracking that occurs at downstream locations. However, the increase in the temperature of the cracking zone as the reactants move across the cracking zone can lead to an increased reaction rate.

Below roughly 400° C., the reaction rate for ammonia cracking can be sufficiently reduced that little or no additional cracking will occur. As a result, in some aspects as the cracking reaction progresses, the beginning portion of the cracking zone can cool sufficiently to effectively stop the cracking reaction within a portion of the reaction zone. This can move the location within the reactor where cracking begins to a location that is further downstream relative to the beginning of the reaction zone. When a sufficient portion of the reaction zone has a temperature below 400° C., or below 500° C., the cracking step within the reaction cycle can be stopped to allow for regeneration. Alternatively, based on the amount of heat introduced into the reactor during regeneration, the cracking portion of the reaction cycle can be stopped based on an amount of reaction time, so that the amount of heat consumed during cracking (plus heat lost to the environment) is roughly in balance with the amount of heat added during regeneration. After the cracking process is stopped, any remaining hydrogen product (generated by the cracking reaction) still in the reactor can optionally be recovered prior to starting the regeneration step of the reaction cycle.

The regeneration process can then be initiated. During regeneration, a fuel such as ammonia and/or H₂, and oxygen, can be introduced into the reactor and combusted. The location where the fuel and oxidant are allowed to mix can be controlled in any convenient manner, such as by introducing the fuel and oxidant via separate channels. By delaying combustion during regeneration until the reactants reach a central portion of the reactor, the non-reforming end of the reactor can be maintained at a cooler temperature. This can also result in a temperature peak in a middle portion of the reactor. During a regeneration cycle, the temperature within the cracking zone can be increased sufficiently to allow for the ammonia cracking during the cracking portion of the cycle. This can result in a peak temperature within the reaction zone of 800° C. or more, or 900° C. or more, or 950° C. or more, such as up to 1100° C. or potentially a still higher temperature. For example, the peak temperature in the reaction zone can be 750° C. to 1100° C., or 750° C. to 1025° C., or 750° C. to 950° C., or 800° C. to 1100° C., or 800° C. to 1025° C., or 800° C. to 950° C., or 900° C. to 1100° C.

In some aspects, the conditions for regeneration can be selected so that the peak temperature that a cracking catalyst is exposed to is lower than the peak temperature in the reaction zone. For example, the peak temperature that cracking catalyst is exposed to can be lower than the peak temperature in the reaction zone by 50° C. or more, or 100° C. or more, such as up to 250° C. or possibly still more. In some aspects, the peak temperature that cracking catalyst is exposed to can be 1000° C. or less, or 950° C. or less, or 900° C. or less, or 850° C. or less, such as down to 750° C. or possibly still lower.

The relative length of time and reactant flow rates for the cracking and regeneration portions of the process cycle can be selected to balance the heat provided during regeneration with the heat consumed during ammonia cracking. For example, one option can be to select a reaction step that has a similar length to the regeneration step. Based on the flow rate of ammonia during the reaction step, an endothermic heat demand for the cracking reaction can be determined. This heat demand can then be used to calculate a flow rate for combustion reactants during the regeneration step. Of course, in other aspects the balance of heat between reforming and regeneration can be determined in other manners, such as by determining desired flow rates for the reactants and then selecting cycle lengths so that the heat provided by regeneration balances with the heat consumed during reforming.

Due to the variation in temperature across the reactor, several options can be used for characterizing the temperature within the reactor and/or within the reaction zone of the reactor. One option for characterizing the temperature can be based on an average bed or average monolith temperature within the reforming zone. In practical settings, determining a temperature within a reactor requires the presence of a measurement device, such as a thermocouple. Rather than attempting to measure temperatures within the reaction zone, an average (bed or monolith) temperature within the reaction zone can be defined based on an average of the temperature at the beginning of the reaction zone and a temperature at the end of the reaction zone. Another option can be to characterize the peak temperature within the reaction zone after a regeneration step in the reaction cycle. Generally, the peak temperature can occur at or near the end of the reaction zone, and may be dependent on the location where combustion is initiated in the reactor. Still another option can be to characterize the difference in temperature at a given location within the reaction zone at different times within a reaction cycle. For example, a temperature difference can be determined between the temperature at the end of the regeneration step and the temperature at the end of the cracking step. Such a temperature difference can be characterized at the location of peak temperature within the reactor, at the entrance to the reaction zone, at the exit from the reaction zone, or at any other convenient location.

In various aspects, the reaction conditions for ammonia cracking can include one or more of an average reaction zone temperature ranging from 350° C. to 800° C. (or more); a peak temperature within the reaction zone of 750° C. to 1100° C.; a temperature difference at the location of peak temperature between the end of a regeneration step and the end of the subsequent cracking step of 25° C. or more, or 50° C. or more, or 100° C. or more, or 200° C. or more, such as up to 500° C. or possibly still higher; a temperature difference at the entrance to the reaction zone between the end of a regeneration step and the end of the subsequent ammonia cracking step of 25° C. or more, or 50° C. or more, or 100° C. or more, or 200° C. or more, such as up to 500° C. or possibly still higher; and/or a temperature difference at the exit from the reaction zone between the end of a regeneration step and the end of the subsequent reforming step of 25° C. or more, or 50° C. or more, or 100° C. or more, or 200° C. or more, such as up to 500° C. or possibly still higher. For example, the temperature difference between the end of the regeneration step and the end of the reaction step at the location of peak temperature and/or at the entrance to the reaction zone can be 80° C. to 220° C., or 80° C. to 160° C., or 100° C. to 220° C., or 100° C. to 160° C., or 120° C. to 220° C., or 120° C. to 160° C.

With regard to the average reaction zone temperature, in various aspects the average temperature for the reaction zone can be 400° C. to 1000° C., or 400° C. to 800° C., or 400° C. to 600° C., or 600° C. to 1000° C., or 600° C. to 800° C., or 500° C. to 700° C. Additionally or alternately, with regard to the peak temperature for the reaction zone (likely corresponding to a location in the reaction zone close to the location for combustion of regeneration reactants), the peak temperature can be 600° C. to 1100° C., or 800° C. to 1100° C., or 600° C. to 950° C., or 800° C. to 950° C., or 600° C. to 800° C. Optionally but preferably, the amount of ammonia conversion (single pass) during the cracking step can be 90 vol % or more of the ammonia in the input flow to cracking, or 95 vol % or more, such as up to having substantially complete conversion of ammonia during the cracking step.

Additionally or alternately, the reaction conditions for cracking ammonia can include a pressure of 0 psig to 500 psig (3.4 MPa-g), or 0 psig to 250 psig (1.7 MPa-g), or 0 psig to 150 psig (1.0 MPa-g), or 0.5 MPa-g to 3.4 MPa-g, or 1.0 MPa-g to 3.4 MPa-g, or 0.5 MPa-g to 1.7 MPa-g, or 1.0 MPa-g to 1.7 MPa-g. Because ammonia cracking results in a net increase in the number of moles of gas (2NH₃<=>3H₂+N₂), lower pressures are more favorable for driving the reaction toward completion. However, from a practical standpoint, the ammonia feed for the ammonia cracking process will often correspond to liquefied ammonia, which can be used to readily generate a pressurized gas flow of ammonia. In many commercial applications, it will be desirable to have a pressurized product. Thus, in some aspects, it can be beneficial to perform the ammonia cracking process at a pressure greater than ambient, in order to reduce or minimize compression costs for using the resulting H₂ product. It is noted that the ammonia cracking reaction is increasingly reversible as pressure increases. For example, ammonia synthesis is typically performed at pressures of roughly 740 psig (5.1 MPa-g) or higher.

Further additionally or alternately, the reaction conditions can include a gas hourly space velocity of reforming reactants of 1000 hr⁻¹ to 50,000 hr⁻¹. The space velocity corresponds to the volume of reactants relative to the volume of monolith per unit time. The volume of the monolith is defined as the volume of the monolith as if it was a solid cylinder.

In aspects where the reaction system includes an optional selective catalytic reduction zone, the peak temperature in the SCR zone during the regeneration step can be 400° C. to 600° C. Additionally or alternately, the average temperature in the SCR zone at the end of the regeneration step can be 300° C. to 500° C.

### Monolith Structure(s) for Supporting Catalyst System

One of the purposes of using a monolith or another supporting structure within a reaction environment is to increase the available surface area for holding a deposited catalyst/catalyst system. To achieve this, some monoliths correspond to a structure with a large plurality of cells or channels that allow gas flow through the monolith. Because each individual cell provides surface area for deposition of catalyst, including a large number of cells or channels per unit area can substantially increase the available surface area for catalyst. Such monoliths can generally be referred to as honeycomb monoliths. It is noted that the terms “cell” and “channel” can be used interchangeably to refer to the passages through a monolith.

In various aspects, a monolith or other structure for providing a surface for the catalyst system may be prepared by manufacturing techniques such as but not limited to conventional ceramic powder manufacturing and processing techniques, e.g., mixing, milling, degassing, kneading, pressing, extruding, casting, drying, calcining, and sintering. The starting materials can correspond to a suitable ceramic powder such as synthetic alumina powder and naturally occurring minerals (e.g. bauxite, bentonite, talc) and an organic binder powder in a suitable volume ratio. Certain process steps may be controlled or adjusted to obtain the desired grain size and porosity range and performance properties, such as by inclusion of various manufacturing, property adjusting, and processing additives and agents as are generally known in the art. For example, the two or more types of oxide powders may be mixed in the presence of an organic binder and one or more appropriate solvents or water for a time sufficient to substantially disperse the powders in each other. As another example, precursors of the oxides present in a monolith may be dissolved in water at a desired ratio, spray dried, and calcined to make a mixed powder. Such precursors include (but are not limited to) chlorides, sulfates, nitrates, and mixtures thereof. The calcined powder can be further mixed in the presence of an organic binder and appropriate solvent(s) to make a mixed “dough”. Then, the mixed “dough” of materials can be placed in a kneader to mix all the ingredient and to enhance plasticity of the mixed “dough”. The number of kneading times and kneading speed can be adjusted. The kneaded “dough” can be placed in a die or form, extruded, dried or otherwise formed into a desired shape. As a non-limiting example, a screw type extruder can be used, and rotation speed of top and bottom screw can be controlled to form a honeycomb shape. As it produces, a wire cutter attached in the screw type extruder operates to make a desired height of the honeycomb monoliths. The resulting extruded body can then be dried to form a “green body”. As a non-limiting example, hot air dryer can be used to slowly remove the residual solvent or water in the extruded body. Yet another non-limiting example, a standalone microwave oven or even a continuous microwave drying oven can be used to form a “green body”. Drying in a microwave oven is advantageous since it shortens total drying time and minimizes potential cracking associated with a rather rapid drying process. The resulting “green body” can then be sintered at temperatures in the range of about 1500° C.˜1700° C. for at least ten minutes, such as from 10 minutes to 48 hours, or possibly from 10 minutes up to 10 days or still longer. Either a batch furnace or a continuous tunnel kiln can be used to sinter the “green body”. During sintering the “green body” shrinks as it densifies and consolidates. The sintering shrinkage is typically about 20˜30%.

The sintering operation may be performed in an oxidizing atmosphere, reducing atmosphere, or inert atmosphere, and at ambient pressure or under vacuum. For example, the oxidizing atmosphere could be air or oxygen, the inert atmosphere could be argon, and a reducing atmosphere could be hydrogen, CO/CO₂ or H₂/H₂O mixtures. Thereafter, the sintered body is allowed to cool, typically to ambient conditions. The cooling rate may also be controlled to provide a desired set of grain and pore structures and performance properties in the particular component.

It is noted that after the sintering operation, any alumina present in the monolith will be substantially converted to α-alumina. The “alpha” phase of alumina is thermodynamically favored at high temperatures, and the temperatures during sintering are sufficient convert substantially all of any other phases of alumina into the “alpha” phase. This is beneficial from a stability standpoint, as converting the alumina in the monolith to α-alumina means that phase transitions are not occurring during exposure of the monolith to the cyclic reforming conditions, where the presence of alternative phases of alumina might facilitate crack formation and/or propagation.

In some aspects, the monolith material can further include an intermediate bond layer. The intermediate bond layer can be applied on monolith surfaces prior to forming a washcoat of active materials (e.g., catalyst). In such aspects, the intermediate bond layer provides a better adherence to the washcoated active material. In such aspects, the intermediate bond layer is a metal oxide, (M)ₓO_{y}, wherein (M) is at least one metal selected from the group consisting of Al, Si, Mg, Ca, Sr, Ba, K, Na, Ti, Zr, Hf, V, Nb, Ta, Cr, Mo, W, Mn, Fe, Ni, Co, Y, La, Ce, and mixtures thereof. Aluminum oxide (a.k.a. alumina), Al₂O₃, is a preferred metal oxide for the bond layer. As an example of how to form an intermediate bond layer, the selected metal oxide, (M)ₓO_{y}, can be dispersed in a solution to form a slurry. The slurry can then be washcoated on the monolith. The monolith washcoated with the selected metal oxide, (M)ₓO_{y}, is dried and sintered at temperatures in the range of 1100° C.˜1600° C. to make the intermediate bonding layer.

It has been discovered that limiting the maximum porosity in the final sintered body tends to effectively, if not actually, limit interconnectivity of the pore spaces with other pore spaces to an extent that increases or maximizes volumetric heat capacity of the sintered body. The porosity ranges for a monolith or other structure can depend upon the desired final component performance properties, but are within a range defined by one or more of the minimum porosity values and one or more of the maximum porosity values, or any set of values not expressly enumerated between the minimums and maximums. Examples of suitable porosity values are 0 vol % to 20 vol % porosity, or 0 vol % to 15 vol %, or 0 vol % to 10 vol %, or 0 vol % to 5 vol %.

The sintered monolith and/or other formed ceramic structure can have any convenient shape suitable for use as a surface for receiving a catalyst or catalyst system. An example of a monolith can be an extruded honeycomb monolith. Honeycomb monoliths can be extruded structures that comprise many (e.g., a plurality, meaning more than one) small gas flow passages or conduits, arranged in parallel fashion with thin walls in between. A small reactor may include a single monolith, while a larger reactor can include a number of monoliths, while a still larger reactor may be substantially filled with an arrangement of many honeycomb monoliths. Each monolith may be formed by extruding monolith blocks with shaped (e.g., square, trigonal, or hexagonal) cross-section and two- or three-dimensionally stacking such blocks above, behind, and beside each other. Monoliths can be attractive as reactor internal structures because they provide high heat transfer capacity with minimum pressure drop.

In some aspects, density, measured by an Archimedes method well-known to the skilled in the art, can be 3.40 gram/cc or more, or 3.50 gram/cc or more, such as up to 3.95 gram/cc which is theoretical density of alumina, or possibly still higher if it contains heavier metal oxides. In some aspects, porosity can be nearly completely closed within the honeycomb monolith walls with the porosity being 10% or less, or 8.0% or less, such as down to 1.0% or possibly still lower.

In some aspects, honeycomb monoliths can be characterized as having open frontal area (or geometric void volume) between 30% to 70%, or 30% to 60%, or 40% to 70%, or 40% to 60%, or 45% to 55%. Additionally or alternately, a monolith can have a conduit density between 50 to 900 cells per square inch (CPSI), or 50 to 600, or 300 to 900, or 300 to 600, or 350 to 550. This roughly corresponds to 7 to 140 cells per square centimeter, or 45 to 140, or 7 to 95, or 45 to 95, or 55 to 85. In some aspects, this type of cell density roughly corresponds to cells or channels that have a diameter/characteristic cell side length of only a few millimeters, such as on the order of roughly one millimeter. Reactor media components, such as the monoliths or alternative bed media, can provide for channels that include a packing with an average wetted surface area per unit volume that ranges from 50 ft⁻¹ to 3000 ft⁻¹ (˜0.16 km⁻¹ to ˜10 km⁻¹), or from 100 ft⁻¹ to 2500 ft⁻¹ (˜0.32 km⁻¹ to ˜8.2 km⁻¹), or from 200 ft⁻¹ to 2000 ft⁻¹ (˜0.65 km⁻¹ to ˜6.5 km⁻¹), based upon the volume of the first reactor that is used to convey a reactant. These relatively high surface area per unit volume values can aid in achieving a relatively quick change in the temperature through the reactor.

Reactor media components can also provide for channels that include a packing that includes a high volumetric heat transfer coefficient (e.g., 0.02 cal/cm³s° C. or more, or 0.05 cal/cm³s° C. or more, or 0.10 cal/cal/cm³s° C. or more); that have low resistance to flow (low pressure drop); that have an operating temperature range consistent with the highest temperatures encountered during regeneration; that have high resistance to thermal shock; and/or that have high bulk heat capacity (e.g., 0.10 cal/cm³s° C. or more, or 0.20 cal/cm³s° C. or more). As with the high surface area values, these relatively high volumetric heat transfer coefficient values and/or other properties can aid in achieving a relatively quick change in the temperature through the reactor, such as generally illustrated by the relatively steep slopes in the exemplary temperature gradient profile graphs, such as in FIGS. 2(a) and 2(b) of FIG. 2. The cited values are averages based upon the volume of reactor used for conveyance of a reactant.

In various aspects, adequate heat transfer rate can be characterized by a heat transfer parameter, ΔTHT, below 500° C., or below 100° C., or below 50° C. The parameter ΔTHT, as used herein, is the ratio of the bed-average volumetric heat transfer rate that is needed for recuperation, to the volumetric heat transfer coefficient of the bed, hv. The volumetric heat transfer rate (e.g. cal/cm³ sec) that is sufficient for recuperation can be calculated as the product of the gas flow rate (e.g. g/sec) with the gas heat capacity (e.g. cal/g° C.) and desired end-to-end temperature change (excluding any reaction, e.g. ° C.), and then this quantity can be divided by the volume (e.g. cm³) of the reactor (or portion of a reactor) traversed by the gas. The volumetric heat transfer coefficient of the bed, hv, can typically be calculated as the product of an area-based coefficient (e.g. cal/cm²s° C.) and a specific surface area for heat transfer (av, e.g. cm²/cm³), often referred to as the wetted area of the packing.

### Catalysts and Catalyst Systems

In various aspects, catalysts and/or catalyst systems are provided for ammonia cracking, along with methods for using such catalyst systems. The catalyst systems can be deposited or otherwise coated on a surface or structure, such as a monolith, to achieve improved activity and/or structural stability. In this discussion, a catalyst system is defined to include at least one catalyst corresponding to one or more catalytic metals, optionally in the form of a metal oxide, and at least one metal oxide support layer. In some aspects, the catalyst and metal oxide support layer can be coated on the monolith at the same time, such as in the form of a washcoat layer on the support. In such aspects, the catalyst can be intermixed with the metal oxide support layer. Alternatively, the catalyst and metal oxide support layer can be deposited sequentially so that the support layer is deposited first, followed by the catalyst. In some aspects, the metal oxide support layer can correspond to a thermally stable metal oxide support layer, such as a metal oxide support layer that is thermally phase stable at temperatures of 800° C. to 1600° C. Optionally, an intermediate bonding layer can be applied to at least a portion of the monolith or other structure prior to depositing the catalyst system. The catalyst systems can be beneficial for use in cyclical reaction environments, such as reverse flow reactors or other types of reactors that are operated using flows in opposing directions and different times within a reaction cycle. The reaction conditions in cyclical reaction environments can also undergo swings in temperature and/or pressure during a reaction cycle. In still other aspects, a catalyst can be deposited without using a corresponding metal oxide support layer.

In some aspects, the catalyst system can correspond to one or more catalysts in a single zone. In other aspects, the catalyst system can correspond to a plurality of catalyst zones. Optionally in such aspects, at least one catalyst zone can include a catalyst that is different from the catalyst(s) in a second catalyst zone.

In some aspects, the catalyst system can include a thermally stable metal oxide support layer. A thermally stable metal oxide support layer corresponds to a metal oxide that is thermally phase stable with regard to structural phase changes at temperatures between 800° C. to 1600° C. In some aspects, such a thermally stable metal oxide support layer can be formed by coating a surface (such using a washcoat) with a metal oxide powder that has a surface area of 20 m²/g or less. For example, the metal oxide powder used for forming a thermally stable metal oxide coating can have a surface area of 0.5 m²/g to 20 m²/g, or 1.0 m²/g to 20 m²/g, or 5.0 m²/g to 20 m²/g. High temperature reforming refers to reforming that takes place at a reforming temperature of 1000° C. or more, or 1100° C. or more, or 1200° C. or more, such as up to 1500° C. or possibly still higher. In various aspects, a catalyst can be annealed at a temperature of 1000° C. or more, or 1100° C. or more, or 1200° C. or more, or 1300° C. or more, such as up to 1600° C. or possibly still higher. This temperature can be substantially similar to or greater than the peak temperature the catalyst is exposed to during a reforming process cycle. An annealing temperature that is substantially similar to a peak temperature can correspond to an annealing temperature that differs from the peak temperature by 0° C. to 50° C.

As an example of a thermally stable metal oxide support layer, alumina has a variety of phases, including α-Al₂O₃, γ-Al₂O₃, and θ-Al₂O₃. A metal powder of α-Al₂O₃ can typically have a surface area of 20 m²/g or less. By contrast, the γ-Al₂O₃ and θ-Al₂O₃ phases have higher surface areas, and a metal powder for use in a washcoat solution of γ-Al₂O₃ and/or θ-Al₂O₃ will have a surface area of greater than 20 m²/g. It is conventionally believed that phases such as θ-alumina or γ-alumina are superior as a supporting structure for a deposited catalyst, as the greater surface per gram of θ-alumina or γ-alumina will allow for availability of more catalyst active sites than α-alumina. However, phases such as γ-Al₂O₃ and θ-Al₂O₃ are not thermally phase stable at temperatures of 800° C. to 1600° C. At such high temperatures, phases such as γ-Al₂O₃ and θ-Al₂O₃ will undergo phase transitions to higher stability phases. For example, at elevated temperatures, γ-Al₂O₃ will first convert to Δ-Al₂O₃ at roughly 750° C.; then 4-Al₂O₃ will convert to θ-Al₂O₃ at roughly 950° C.; then θ-Al₂O₃ will then convert to α-Al₂O₃ with further exposure to elevated temperatures between 1000° C. and 1100° C. Thus, α-Al₂O₃ is the thermally phase stable version of Al₂O₃ at temperatures of 800° C. to 1600° C.

In various aspects, one option for adding a catalyst system to a monolith can be to coat the monolith with a mixture of a catalyst (optionally in oxide form) and metal oxide support layer. For example, powders of the catalyst oxide and the metal oxide support layer can be used to form a washcoat that is then applied to the monolith (or other structure). This can result in a catalyst system where the catalyst is mixed within/distributed throughout the metal oxide support layer, as opposed to the catalyst being deposited on top of the metal oxide support layer. In other words, at least a portion of the catalyst system can correspond to a mixture of the catalyst and the support layer. In other aspects, any convenient method for depositing or otherwise coating the catalyst system on the monolith or other structure can be used. The weight of the catalyst system on the monolith (or other structure) can correspond to 0.1 wt % to 10 wt % of the total weight of the catalyst system plus monolith, or 0.5 wt % to 10 wt %, or 2.0 wt % to 10 wt %, or 0.1 wt % to 6.0 wt %, or 0.5 wt % to 6.0 wt %, or 2.0 wt % to 6.0 wt %.

A catalyst system can be applied to a monolith or other structure, for example, by applying the catalyst system as a washcoat suspension. To form a washcoat suspension, the catalyst system can be added to water to form an aqueous suspension having 10 wt % to 50 wt % solids. For example, the aqueous suspension can include 10 wt % to 50 wt % solids, or 15 wt % to 40 wt %, or 10 wt % to 30 wt %. Optionally, an acid or a base can be added to the aqueous suspension to reduce or raise, respectively, the pH so as to change the particle size distribution of the alumina catalyst and/or binder particles. For example, acetic acid or another organic acid can be added to achieve a pH of 3 to 4. The suspension can then be ball milled (or processed in another manner) to achieve a desired particle size for the catalyst particles, such as a particle size of 0.5 μm to 5 μm. After milling, the suspension can be stirred until time for use so that the particles are distributed substantially uniformly in the solution.

The washcoat suspension can then be applied to a monolith structure to achieve a desired amount of catalyst (such as nickel) on the monolith surface. As an example, in one aspect a washcoat thickness of 10 microns was achieved by forming a washcoat corresponding to 10 wt % of the monolith structure. Any convenient type of monolith structure can be used to provide a substantial surface area for support of the catalyst particles. The washcoat can be applied to the monolith to form cells having inner surfaces coated with the catalyst. One option for applying the washcoat can be to dip or otherwise submerge the monolith in the washcoat suspension.

After clearing the cell channels of excess washcoat, the catalyst system coated on the monolith can be optionally dried. Drying can correspond to heating at 100° C. to 200° C. for 0.5 hours to 24 hours. After any optional drying, calcination can be performed. In some aspects, calcining can correspond to heating at 200° C. to 800° C. for 0.5 hours to 24 hours. In some other aspects, calcining can correspond to heating at 800° C. to 1300° C. for 0.5 hours to 24 hours.

In other aspects, a high temperature calcination step can be used, so that the calcining temperature for the catalyst system coated on the monolith is substantially similar to or greater than the peak temperature the monolith will be exposed to during the cyclic high temperature reforming reaction. For a monolith in a high temperature zone, this can correspond to calcining the catalyst system coated on the monolith at a temperature of 800° C. or more, or 1000° C. or more, or 1200° C. or more, or 1300° C. or more, such as up to 1600° C. or possibly still higher. It is noted that if multiple catalyst zones are present, the calcination for monoliths in different catalyst zones can be different.

It has been unexpectedly discovered that performing calcination at a temperature similar to or greater than the peak temperature during the cyclic high temperature reforming process can unexpectedly allow for improved activity for the catalyst system and/or adhesion of the catalyst system to the underlying monolith. Without being bound by any particular theory, it is believed that exposing the monolith and deposited catalyst system to elevated temperatures prior to exposure of the catalyst to a cyclic reaction environment can facilitate forming a stable interface between the catalyst system and the monolith. This stable interface can then have improved resistance to the high temperature oxidizing and/or reducing environment during the reforming process, resulting in improved stability for maintaining the catalyst system on the surface of the monolith.

One of the distinctions between using a catalyst system including a thermally stable metal oxide and a catalyst system that does not use a thermally stable oxide is that the catalyst system including the thermally stable metal oxide can have improved adhesion to the underlying support structure after exposure to the cyclic high temperature reforming environment.

Adhesion of the washcoat after operation can be quantified by the amount of force needed to de-adhere the washcoat. In prior operation, washcoats comprised of theta and gamma alumina were de-adhered with minimal force, such as an amount of force similar to a paint brush stroke (weak). In operation with the phase stable supports, the force needed to de-adhere the washcoat was high, similar to the scraping of dried epoxy off of a glass surface (strong). Due to these differences, only small amounts of washcoat could be de-adhered from the phase stable materials, whereas large amounts of washcoat could be de-adhered from the gamma and theta supports.

Other methods for evaluating adhesion of the washcoat include, but are not limited to, (i) a thermal cycling method, (ii) a mechanical attrition method, and (iii) an air-knife method. As a non-limiting example, the thermal cycling method can be performed by heating the washcoated materials to high temperatures in the range of 800 to 1300° C., cooling the heated substrates to ambient temperature, and repeating such a cycle at least five times. As another non-limiting example, the mechanical attrition method can be performed by placing the washcoated materials inside a plastic container and shaking the container on a vibration table for at least 30 minutes.

In various aspects, suitable catalytic metals can include, but are not limited to, Ni, Co, Fc, Pd, Rh, Ru, Pt, Ir, Cu, Ag, Au, Zr, Cr, Ti, V, Mo, Nb, and combinations thereof. The catalytic metal can be selected based on the desired type of catalytic activity. Such catalytic metals may be used in a catalyst in the form of a metal oxide. For ammonia cracking, suitable catalytic metals can include nickel, iron, ruthenium, cobalt, platinum, palladium, or combinations thereof. The weight of catalytic metal oxide in a catalyst system can range from 0.1 wt % to 70 wt %, or 1.0 wt % to 60 wt %, or 2.0 wt % to 50 wt %, relative to the total weight of the catalyst system. In some aspects where the catalytic metal corresponds to a precious metal or noble metal, the weight of catalytic metal oxide in the catalyst system can range from 0.1 wt % to 10 wt %, or 0.2 wt % to 7.0 wt %, or 0.5 wt % to 4 wt %.

As an example, an ammonia cracking catalyst system can be composed of Ni as a catalytic metal (NiO as a catalytic metal oxide) and Al₂O₃ as a metal oxide support. It is noted that this catalyst system can at least partially convert to NiAl₂O₄ during portions of the cyclic reforming process. This catalyst system can be formed, for example, by using a mixture of NiO and Al₂O₃, as a washcoat on α-Al₂O₃ monoliths.

For selective catalytic reduction, suitable catalytic metals can include vanadium, molybdenum, tungsten, copper, or a combination thereof. It is noted that SCR can also be performed using one or more zeotype materials and/or using a combination of one or more zeotype materials in combination with one or more catalytic metals. In aspects where both zeotype materials and catalytic metals are used, the zeotype materials and catalytic metals can be mixed together, or separate stages of zeolite and catalytic metal can be used. The weight of catalytic metal oxide and/or zeotype in a catalyst system can range from 0.1 wt % to 70 wt %, or 1.0 wt % to 60 wt %, or 2.0 wt % to 50 wt %, relative to the total weight of the catalyst system.

In various aspects, suitable metals for the metal oxide support layer in the catalyst system can include, but are not limited to, Al, Si, Mg, Ca, Sr, Ba, K, Na, Ti, Zr, Hf, V. Nb, Ta, Cr, Mo, W, Mn, Fe, Ni, Co, Y, La, Ce, and combinations thereof. The metal (or metals) for the metal oxide support can be selected so that the metal oxide support substantially does not convert to metallic form under the reducing conditions present in the cyclic reaction environment. As an example, when the catalytic metal oxide is NiO, one option for a metal oxide support is Al₂O₃, preferably α-Al₂O₃. Another example of a suitable metal oxide support, optionally, in combination with NiO as the catalytic metal oxide, is a mixture of Al₂O₃ with SiO₂, MgO and/or TiO₂. In such an example, SiO₂ can combine with Al₂O₃ to form a mullite phase that could increase resistance to thermal shock and/or mechanical failure. Additionally or alternately, in such an example, MgO and/or TiO₂ can be added. The weight of metal oxide support in the catalyst bed can range from 1.0 wt % to 40 wt %, or 2.0 wt % to 30 wt %, or 3.0 wt % to 20 wt %, relative to the total weight of the monolith in the catalyst bed.

In various aspects, a metal oxide support layer (such as a thermally stable metal oxide support layer) can correspond to at least one oxide selected from the corundum group, stabilized zirconia, perovskite, pyrochlore, spinel, hibonite, zeolite, and mixtures thereof. The weight of metal oxide support can range from 1.0 wt % to 40 wt %, or 2.0 wt % to 30 wt %, or 3.0 wt % to 20 wt %, relative to the total weight of the monolith plus catalyst system.

One category of metal oxide support layers can correspond to traditional refractory oxides that are commonly used to form supported catalysts. For example, the metal oxide support can correspond to α-Al₂O₃, LaAlO₃, LaAl₁₁O₁₈, MgO, CaO, ZrO₂, TiO₂, CeO₂, Y₂O₃, La₂O₃, SiO₂, Na₂O, K₂O, and mixtures thereof. This group is defined herein as the “corundum” group of oxides, although many of the oxides in this group do not have the corundum lattice structure. For example, CeO₂ and MgO can both have a halite crystal structure. α-Al₂O₃ consists essentially of a dense arrangement of oxygen ions in hexagonal closest-packing with Al³⁺ ions in two-thirds of the available octahedral sites. LaAlO₃, often abbreviated as LAO, is an optically transparent ceramic oxide with a distorted perovskite structure. LaAl₁₁O₁₈ can be formed through the solid state reaction of LaAlO₃ and α-Al₂O₃. Plate-like crystals of LaAl₁₁O₁₈ are particularly useful as a metal oxide support since catalytic metals can be trapped between plate-like crystal structures. It suppresses sintering of minute catalytic metals in the active material which is washcoated on the monolith of the catalyst bed. Additional examples of oxides from the corundum group can include, but are not limited to: i) 95 wt % α-Al₂O₃ and 5 wt % SiO₂; ii) 93 wt % α-Al₂O₃, 5 wt % SiO₂ and 2 wt % MgO; iii) 94 wt % α-Al₂O₃, 4 wt % SiO₂, 2 wt % MgO and 1 wt % Na₂O; iv) 95 wt % α-Al₂O₃, 4 wt % SiO2 and 1 wt % TiO₂; v) 7 wt % CeO₂ and 93 wt % MgO; vi) 5 wt % CaO and 95 wt % α-Al₂O₃; vii) 5 wt % MgO, 5 wt % CeO₂ and 90 wt % α-Al₂O₃; viii) 20 wt % ZrO₂ and 80 wt % CeO₂, ix) 5 wt % CeO₂, 20 wt % ZrO₂ and 75 wt % α-Al₂O₃, and x) 6 wt % La₂O₃ and ₉₄ wt % α-Al₂O₃, based on the weight of metal oxide support.

As an example, the catalyst system can correspond to a mixture of NiO and Al₂O₃. Under the cyclic high temperature reforming conditions, the NiO and the Al₂O₃ in the will react to form a mixed phase of NiO, NiAl₂O₄, and/or Al₂O₃. Additionally, based on cyclic exposure to oxidizing and reducing conditions, the catalyst can be converted from a substantially fully oxidized state, such as a combination of oxides including NiO, NiAl₂O₄ and Al₂O₃, to various states including at least some Ni metal supported on a surface. In this discussion, a catalyst system that includes both NiO and Al₂O₃ is referred to as an NiAl₂O₄ catalyst system.

Based on the stoichiometry for combining NiO and Al₂O₃ to form NiAl₂O₄, a catalyst including a molar ratio of Al to Ni of roughly 2.0 (i.e., a ratio of 2:1) could result in formation of NiAl₂O₄ with no remaining excess of NiO or Al₂O₃. Thus, one option for forming an NiAl₂O₄ catalyst is to combine NiO and Al₂O₃ to provide a stoichiometric molar ratio of Al to Ni of roughly 2.0. In some other aspects, an excess of NiO can be included in the catalyst relative to the amount of alumina in the support, so that at least some NiO is present in a fully oxidized state. In such aspects, the molar ratio of Al to Ni in the catalyst can be less than 2.0. For example, the molar ratio of Al to Ni in a NiO/NiAl₂O₄ catalyst can be 0.1 to 2.0, or 0.1 to 1.9, or 0.1 to 1.5, or 0.5 to 2.0, or 0.5 to 1.9, or 0.5 to 1.5, or 1.0 to 2.0, or 1.0 to 1.9, or 1.2 to 1.5, or 1.5 to 2.0, or 1.5 to 1.9. In still other aspects, an excess of Al₂O₃ can be included in the catalyst relative to the amount of Ni, so that at least some Al₂O₃ is present in a fully oxidized state. In such aspects, the molar ratio of Al to Ni in the catalyst can be greater than 2.0. For example, the molar ratio of Al to Ni in a NiAl₂O₄/Al₂O₃ catalyst can be 2.0 to 10, or 2.1 to 10, or 2.0 to 5.0, or 2.1 to 5.0, or 2.0 to 4.0, or 2.1 to 4.0.

In various aspects, a NiAl₂O₄ catalyst can be incorporated, for example, into a washcoat that is then applied to a surface or structure within a reactor, such as a monolith. By providing NiO and Al₂O₃ as a catalyst system that is then deposited on a separate monolith (which can then form NiAl₂O₄ under the cyclic conditions), the activity of the catalyst can be maintained for unexpectedly longer times relative to using a monolith that directly incorporates NiO and Al₂O₃ into the monolith structure.

When a composition is formed that includes both nickel oxide and alumina, the NiO and Al₂O₃ can react to form a compound corresponding to NiAl₂O₄. However, when NiO (optionally in the form of NiAl₂O₄) is exposed to reducing conditions, the divalent Ni can be reduced to form metallic Ni. Thus, under cyclic reforming conditions that include both high temperature oxidizing and reforming environments, at least a portion of NiAl₂O₄ catalyst can undergo cyclic transitions between states corresponding to Ni metal and Al₂O₃ and NiAl₂O₄. It is believed that this cyclic transition between states can allow a NiAl₂O₄ catalyst to provide unexpectedly improved activity over extended periods of time. Without being bound by any particular theory, it is believed that at least part of this improved activity for extended time periods is due to the ability of Ni to “re-disperse” during the successive oxidation cycles. It is believed this re-dispersion occurs in part due to the formation of NiAl₂O₄ from NiO and Al₂O₃. Catalyst sintering is a phenomenon known for many types of catalysts where exposure to reducing conditions at elevated temperature can cause catalyst to agglomerate on a surface. Thus, even if the surface area of the underlying surface remains high, the agglomeration of the catalyst may reduce the amount of available catalyst active sites, as the catalyst sinters and forms lower surface area deposits on the underlying surface. By contrast, it is believed that the cyclic transition between states can allow the Ni in an NiAl₂O₄ catalyst system to retain good dispersion, so that catalyst activity can be maintained. It is believed that further advantage can be obtained by using a sufficient amount of excess oxygen during the regeneration step so that all available Ni is oxidized back to NiO and/or NiAl₂O₄.

It is noted that by supplying both NiO as a catalyst and Al₂O₃ as a metal oxide support layer as part of the catalyst system, the alumina for forming NiAl₂O₄ is already provided as part of the catalyst system. It is believed that this reduces or minimizes interaction of Ni with any alumina that may be present in the monolith composition, and therefore reduces or minimizes degradation of the underlying monolith when exposed to successive cycles of high temperature oxidation and reduction.

NiO supported on yttria-stabilized zirconia (NiO/YSZ) is another example of an Ni-containing catalyst system that can be used for reforming. Although α-Al₂O₃ is phase stable, it is able to react with NiO at high temperature to form NiAl₂O₄. It is believed, however, that YSZ does not react with Ni (NiO) at high temperatures. Thus, it is believed that in the NiO/YSZ system, a cyclic oxidation and reduction of Ni to NiO and back to Ni metal does occur, but redispersion does not occur. However, NiO/YSZ can still provide stable reforming activity in a cyclic high temperature reforming environment. In some aspects, to assist with bonding of NiO/YSZ to a monolith, an intermediate oxide layer of α-Al₂O₃ can first be deposited as a washcoat on the monolith. The NiO/YSZ layer can then be deposited on the intermediate oxide layer.

NiO/YSZ represents an alternative type of catalyst system, as YSZ is a phase stable support that does not react with Ni to form a different material. In order to determine stability of the support oxide layer, a first sample of NiO/YSZ was exposed to calcining at 1300° C., while a second sample was steamed in air at 1000° C. X-ray diffraction was used to verify that no phase changes occurred. However, based on Brunauer-Emmett-Teller (BET) surface area analysis, it was observed that the surface area of the NiO/YSZ sample was roughly 53 m²/g prior to the calcining and steaming, and roughly 5 m²/g after the calcining and steaming.

Still another example of a catalyst system containing Ni can be NiO on a perovskite oxide, such as Sr_{0.65}La_{0.35}TiO₃ (SLT).

### Additional Embodiments

Embodiment 1. A method for cracking ammonia in a cyclic flow reaction system, comprising: mixing a fuel flow comprising ammonia and a first O₂-containing flow in a reaction system to form a mixture comprising an O₂ content of 0.1 vol % or more, the reaction system comprising a reaction zone and a recuperation zone; reacting the mixture to heat one or more surfaces in the reaction zone to a cracking temperature, at least a portion of the reaction zone comprising a cracking catalyst; and exposing a reactant stream comprising ammonia to the cracking catalyst in the reaction zone under cracking conditions to form a hydrogen-containing effluent, a direction of flow of the reactant stream being reversed relative to a direction of flow for the mixture.

Embodiment 2. The method of Embodiment 1, wherein reacting the mixture forms a flue gas comprising nitrogen oxides, the method further comprising exposing the flue gas to selective catalytic reduction conditions in the presence of a catalytic reduction catalyst and a reductant in a selective catalytic reduction zone, the reductant optionally comprising ammonia.

Embodiment 3. The method of Embodiment 2, wherein the reductant is introduced into the reaction system at an interface between the selective catalytic reduction zone and the reaction zone.

Embodiment 4. The method of Embodiment 2 or 3, wherein the catalytic reduction catalyst comprises vanadium, molybdenum, tungsten, copper, a zeotype material, or a combination thereof, the catalytic reduction catalyst optionally comprising a mixture of a zeotype material and at least one of vanadium, molybdenum, tungsten, copper, or a combination thereof.

Embodiment 5. The method of any of Embodiments 2 to 4, wherein the selective catalytic reduction zone comprises an average temperature of 300° C. to 500° C.

Embodiment 6. The method of any of the above embodiments, wherein the cracking conditions comprise a peak temperature in the reaction zone of 750° C. to 1100° C.; or wherein the cracking conditions comprise an average temperature in the reaction zone of 400° C. to 700° C.; or a combination thereof.

Embodiment 7. The method of any of the above embodiments, wherein the fuel flow further comprises 0.1 vol % to 5.0 vol % hydrogen; or wherein the fuel flow comprises at least a portion of the hydrogen-containing effluent; or a combination thereof.

Embodiment 8. The method of any of the above embodiments, wherein the O₂-containing stream comprises air.

Embodiment 9. The method of any of the above embodiments, wherein the mixture comprises 90% to 200% of a stoichiometric amount of O₂ for combustion of the fuel flow.

Embodiment 10. The method of any of the above embodiments, wherein the cracking catalyst comprises Ni, NiAl₂O₄, or a combination thereof.

Embodiment 11. A reverse flow reactor system, comprising: a reaction zone comprising a cracking catalyst; a recuperation zone comprising a fuel inlet, an oxidant inlet, and a reaction effluent outlet; a mixer at an interface between the recuperation zone and the reaction zone, the recuperation zone comprising at least one recuperation zone flow path providing fluid communication between the fuel inlet and the mixer, and a selective catalytic reduction zone comprising a catalytic reduction catalyst, an ammonia reactant inlet, and a flue gas outlet.

Embodiment 12. The system of Embodiment 11, wherein the selective catalytic reduction zone further comprises a reductant inlet.

Embodiment 13. The system of Embodiment 12, wherein the selective catalytic reduction zone further comprises a mixer, the reductant inlet comprising bypass channels providing fluid communication between the selective catalytic reduction zone and the recuperation zone.

Embodiment 14. The system of any of Embodiments 11-13, wherein the cracking catalyst comprises Ni, NiAl₂O₄, or a combination thereof.

Embodiment 15. The method of any of Embodiments 11-14, wherein the catalytic reduction catalyst comprises vanadium, molybdenum, tungsten, copper, a zeotype material, or a combination thereof, the catalytic reduction catalyst optionally comprising a mixture of a zeotype material and at least one of vanadium, molybdenum, tungsten, copper, or a combination thereof.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A method for cracking ammonia in a cyclic flow reaction system, comprising:
mixing a fuel flow comprising ammonia and a first O₂-containing flow in a reaction system to form a mixture comprising an O₂ content of 0.1 vol % or more, the reaction system comprising a reaction zone and a recuperation zone;
reacting the mixture to heat one or more surfaces in the reaction zone to a cracking temperature, at least a portion of the reaction zone comprising a cracking catalyst; and
exposing a reactant stream comprising ammonia to the cracking catalyst in the reaction zone under cracking conditions to form a hydrogen-containing effluent, a direction of flow of the reactant stream being reversed relative to a direction of flow for the mixture.

2. The method of claim 1, wherein reacting the mixture forms a flue gas comprising nitrogen oxides, the method further comprising exposing the flue gas to selective catalytic reduction conditions in the presence of a catalytic reduction catalyst and a reductant in a selective catalytic reduction zone.

3. The method of claim 2, wherein the reductant comprises ammonia.

4. The method of claim 2, wherein the reductant is introduced into the reaction system at an interface between the selective catalytic reduction zone and the reaction zone.

5. The method of claim 2, wherein the catalytic reduction catalyst comprises vanadium, molybdenum, tungsten, copper, a zeotype material, or a combination thereof.

6. The method of claim 2, wherein the catalytic reduction catalyst comprises a mixture of a zeotype material and at least one of vanadium, molybdenum, tungsten, copper, or a combination thereof.

7. The method of claim 2, wherein the selective catalytic reduction zone comprises an average temperature of 300° C. to 500° C.

8. The method of claim 1, wherein the cracking conditions comprise a peak temperature in the reaction zone of 750° C. to 1100° C.

9. The method of claim 1, wherein the cracking conditions comprise an average temperature in the reaction zone of 400° C. to 700° C.

10. The method of claim 1, wherein the fuel flow further comprises 0.1 vol % to 5.0 vol % hydrogen.

11. The method of claim 10, wherein the fuel flow comprises at least a portion of the hydrogen-containing effluent.

12. The method of claim 1, wherein the O₂-containing stream comprises air.

13. The method of claim 1, wherein the mixture comprises 90% to 200% of a stoichiometric amount of O₂ for combustion of the fuel flow.

14. The method of claim 1, wherein the cracking catalyst comprises Ni, NiAl₂O₄, or a combination thereof.

15. A reverse flow reactor system, comprising:
a reaction zone comprising a cracking catalyst;
a recuperation zone comprising a fuel inlet, an oxidant inlet, and a reaction effluent outlet;
a mixer at an interface between the recuperation zone and the reaction zone, the recuperation zone comprising at least one recuperation zone flow path providing fluid communication between the fuel inlet and the mixer; and
a selective catalytic reduction zone comprising a catalytic reduction catalyst, an ammonia reactant inlet, and a flue gas outlet.

16. The system of claim 15, wherein the selective catalytic reduction zone further comprises a reductant inlet.

17. The system of claim 16, wherein the selective catalytic reduction zone further comprises a mixer, the reductant inlet comprising bypass channels providing fluid communication between the selective catalytic reduction zone and the recuperation zone.

18. The system of claim 15, wherein the cracking catalyst comprises Ni, NiAl₂O₄, or a combination thereof.

19. The method of claim 15, wherein the catalytic reduction catalyst comprises vanadium, molybdenum, tungsten, copper, a zeotype material, or a combination thereof.

20. The method of claim 15, wherein the catalytic reduction catalyst comprises a mixture of a zeotype material and at least one of vanadium, molybdenum, tungsten, copper, or a combination thereof.
